(19) United States
(12) Patent Application Publication
(10) Pub. No.: US 2010/0282565 A1
(43) Pub. Date: Nov. 11, 2010

(54) FRICTION LAYER CARRIER DEVICE AND METHOD FOR MANUFACTURING THE FRICTION LAYER CARRIER DEVICE

(75) Inventors: Knut Erdmann, Nurnberg (DE); Jochen Heider, Schwabach (DE); Meinrad Holderied, Igensdorf (DE)

Correspondence Address: LERNER GREENBERG STEMER LLP, P O BOX 2480, HOLLYWOOD, FL, 33022-2480, US

(73) Assignee: DIEHL METALL STIFTUNG & CO. KG, Röthenbach (DE)

(21) Appl. No.: 12/841,647

(22) Filed: Jul. 22, 2010

Related U.S. Application Data
(63) Continuation of application No. PCT/EP2009/000306, filed on Jan. 20, 2009.

(30) Foreign Application Priority Data
Jan. 24, 2008 (DE) 10 2008 005 835.1

(51) Int. Cl. F16D 13/60; B32B 3/00; B32B 37/24; B32B 38/04

(52) U.S. Cl. 192/107 M; 428/172; 156/242; 156/244.11; 156/250

(57) ABSTRACT

A friction layer carrier device has a basic element with a basic element contact surface and a friction layer lining body with a lining contact surface. The friction layer lining body is fastened to the basic element in such a way that the basic element contact surface and the lining contact surface are joined together in adhesive regions via an adhesive. At least one depression region, which allows degassing of the adhesive, is introduced into the basic element contact surface and/or into the lining contact surface.

### CROSS-REFERENCE TO RELATED APPLICATION

This application is a continuation, under 35 U.S.C. §120, of copending international application No. PCT/EP2009/000306, filed Jan. 20, 2009, which designated the United States; this application also claims the priority, under 35 U.S.C. §119, of German patent application No. DE 10 2008 005 835.1, filed Jan. 24, 2008; the prior applications are herewith incorporated by reference in their entirety.

### BACKGROUND OF THE INVENTION

### Field of the Invention

The invention relates to a friction layer or friction coat carrier device with a basic element having a basic element contact surface, and with a friction layer lining body having a lining contact surface. The friction layer lining body is fastened to the basic element in such a way that the basic element contact surface and the lining contact surface are joined together in adhesive regions via an adhesive. The invention further relates to a method for the production of such a device.

In automotive technology and in mechanical engineering, in general, use is often made of devices allowing force or torque to be transmitted via a temporary frictional engagement connection. Devices of the type, also referred to as tribological systems, conventionally have at least one friction layer applied to a carrying body, the carrying body being pressed with the friction layer against a friction partner to form the frictional engagement.

Prior art examples of tribological systems of the type are provided by friction clutches, brakes or in synchronous devices by clutch discs, brake linings or synchronizing rings.

Commonly assigned U.S. Pat. No. 7,635,511 B2 and its German counterpart DE 103 34 895 B1, which is believed to describe the most pertinent prior art, relates to a synchronizer ring with a carrying body which has a conical friction surface and to which a friction layer made of a carbon fiber-containing material is adhered.

### SUMMARY OF THE INVENTION

It is accordingly an object of the invention to provide a friction layer carrier device and production method which overcome various disadvantages of the heretofore-known devices and methods of this general type and which provide for a friction layer carrier device and also a method for the production thereof with the aim of improving the production quality of friction layer carrier devices.

With the foregoing and other objects in view there is provided, in accordance with the invention, a friction layer carrier device, comprising:

a basic element formed with a basic element contact surface; and

a friction layer lining body fastened to the basic element, the friction layer lining body having a lining contact surface;

adhesive joining the friction layer lining body to the basic element at adhesive regions, with the contact surface of the basic element adjoining the lining contact surface of the friction layer lining body;

at least one of the basic element contact surface and the lining contact surface having a depression region with depressions formed therein for degassing the adhesive.

In the most general terms, the invention relates to a friction layer carrier device formed preferably as a friction partner in a tribological system and/or in a frictional engagement system.

The friction layer carrier device comprises a one-part or multipart basic element and a one-part or multipart and/or single-layered or multilayered friction layer lining body. The basic element is embodied as a carrying body made preferably of metal, in particular of steel, for example of sintered steel, brass or of a composite of steel and brass.

The basic element has a basic element contact surface and the friction layer lining body a lining contact surface, the contact surfaces being joined together in adhesive regions via an adhesive. The adhesive is advantageously in the form of a thermally stable and/or oil-resistant adhesive, for example of a phenolic resin or an epoxy resin adhesive.

The invention proposes that at least one depression region, which allows degassing of the adhesive, be introduced in at least one of the contact surfaces, i.e. in the basic element contact surface and/or in the lining contact surface.

It is a consideration of the invention that during the adhering of the friction layer lining body to the basic element, in particular if this takes place at elevated temperature, gases, which originate from solvent residues or else from reaction products of the adhesive, can issue from the adhesive volume. The issuing gases can greatly impair the adhesive result, with regard both to adhesive strength and to the dimensional stability of the resulting friction layer carrier device. In the worst case, this can lead even to the formation in the adhesive layer of bubbles which on the one hand destroy the adhesive structure and lead to the low adhesive strengths and on the other hand result in non-uniform adhesive layer thicknesses; this inadmissibly reduces the dimensional stability of the friction layer carrier device. The at least one depression region in at least one of the contact surfaces ensures that the adhesive can degas sufficiently without adversely changing the adhesive result with regard to strength or dimensional stability.

In the case of a particularly preferred embodiment, provision is made for the at least one depression region to form a ventilation structure for the adhesive regions, in particular adjoining the at least one depression region. A plurality of non-interconnected depression regions or ventilation structures, but also a common depression region or a common ventilation structure, can in this case be embodied. It is also preferred for the ventilation structure and/or the depression region to be outwardly opened, thus allowing the gases to be drawn off. For example, one or more ventilation channels, opening at the edge side on the contact surfaces, are introduced for free degassing of the adhesive.

With the object of ensuring sufficiently marked degassing, it is preferred for the shortest distance from a point in the adhesive regions to a possible vent, i.e. to a depression region, of a ventilation structure or to an edge-side opening to be formed so as to be less 5 mm, preferably less than 3 mm. With this optional feature, the adhesive regions are structured or divided in such a way that no adverse effects occur for the adhesive result even in the event of accumulation of gases.

In the case of a particularly preferred embodiment, the at least one depression region is formed in the radial direction so as to be adhesive-free at least in certain portions. In other words, the depression region contains a flow volume which in terms of flow preferably extends without interruption over the entire depression region and/or an associated ventilation structure. As a result of the fact that the adhesive does not completely fill out the depression region, there remains a free volume which is preferably in communication with the environment, thus allowing the gas of the adhesive to be drawn off via the free volume.

In the case of a preferred constructional embodiment of the invention, the depression regions are formed as grooves, flutes, criss-cross patterns and/or channels. In terms of cross section, the depression regions can be formed in any desired manner, i.e. for example so as to be rounded, rectangular or V-shaped, etc. With regard to the course of the depression regions on the surface to be adhered or on at least one of the contact surfaces, there is also broad latitude, i.e. for example channels which extend obliquely to the contact surface, and may intersect, are beneficial in order to draw off the gas. However, grooves or a groove, in particular a radially encircling groove, are also sufficient, in particular if at least one contact surface has a degassing channel which is connected in terms of flow on the one hand to the groove and on the other hand to the environment.

In principle, it is possible for the at least one depression region to be introduced in the basic element, into the friction layer lining body or into both. It is however particularly preferred for the at least one depression region to be arranged in the basic element, as the basic element is usually more solid in its formation than the friction layer lining body, so that on the one hand introduction is easier and on the other hand the risk of later deactivation of the depression region, for example as a result of accidental deformation, is all but ruled out.

Preferably, the basic element contact surface and lining contact surface are shaped so as to be complementary to each other, wherein the contact surface course or the plane of adhesion can be curved, cylindrical sleeve-shaped, conical sleeve-shaped or flat in its formation. The invention can thus be carried out irrespective of whether the parts to be bonded have for example a planar, arcuate or annular geometry.

In the case of a particularly preferred embodiment, the basic element contact surface and/or the lining contact surface are smooth and/or gas-tight in their formation. This embodiment occurs above all when the basic element is made of a metal and the edge coat, forming the lining contact surface, of the friction layer lining body is also made of metal. For example, the carriers used for friction layers are metal foils which are gas-tight. This embodiment highlights the advantage of the invention particularly clearly, as in the past the degassing of the adhesive and the drawbacks resulting therefrom prevented adhesion of this combination of adhesive partners with gas-tight contact surfaces. The term “gas-tight” preferably refers to the property according to which gases formed during the adhesion cannot be drawn off or cannot be sufficiently drawn off through the contact surfaces and collect between the contact surfaces, where they have negative repercussions, such as for example reducing the adhesive strength or limiting the dimensional stability. Alternatively or additionally, one or both contact surfaces are formed so as to be pore-free and/or free from passages for gases in the radial direction.

In the case of a preferred embodiment of the invention, the friction layer carrier device is in the form of a brake lining body, in particular a brake disc, a clutch body, in particular a clutch disc, a synchronizing body, in particular a synchronizing ring.

In the case of a development of the invention, the friction layer lining body is constructed of at least two layers, one layer being in the form of a carrier, in particular a metal strip and/or a sheet of metal foil, carrying at least one friction layer layer which is for example in the form of a sintered-on friction lining.

In the case of a specific, preferred embodiment of the invention, the friction layer carrier device is in the form of a synchronizing ring, optionally of an outer ring, an inner ring or an intermediate ring, which is used for example in multiple-cone synchronizations in vehicle transmission systems. The synchronizing ring has a cone-shaped and/or conical sleeve surface as the basic element contact surface, which preferably assumes an angle of between 6° and 10° relative to the axis of rotation of the synchronizing ring. A coated or sintered metal foil is adhered on the basic element contact surface as the friction layer lining body. In the case of this specific embodiment, it is particularly preferred if the cone-shaped and/or conical sleeve surface carries the at least one depression region.

In other words, with the above and other objects in view there is provided, in accordance with a specific implementation of the invention, a synchronizer ring, which comprises:

a ring with a cone-shaped and/or conical sleeve surface forming a contact surface; and

a coated metal foil forming a friction layer lining body bonded into the cone-shaped and/or conical sleeve surface; and

adhesive joining the coated metal foil to the basic element at adhesive regions, with the contact surface of the basic element joining the lining contact surface of the friction layer lining body;

at least one of the contact surface of the ring and the metal foil having a depression region with depressions formed therein for degassing the adhesive.

With the above and other objects in view there is aslo provided, as a further development of the invention, a method for producing the friction layer carrier device, such as described herein. In this context, at least one depression region, which allows degassing of the adhesive, is molded, embossed, embodied with removal of material and/or with or without cutting into the basic element contact surface and/or into the lining contact surface. The depression region can thus be introduced by means of shaping, reshaping and/or separating, in particular removing material. Specifically, the depression region is found to be a depression structure relative to the contact surfaces which are otherwise smooth in their formation in the adhesive regions.

In the case of a specific development of the method, the application of adhesive is selected in such a way that the at least one depression region is incompletely filled after the adhesion and/or remains permeable in terms of flow. This development again emphasizes the idea that the at least one depression region forms a continuous ventilation structure.

Other features which are considered as characteristic for the invention are set forth in the appended claims.

Although the invention is illustrated and described herein as embodied in a friction layer carrier device and method for manufacturing the friction layer carrier device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a partly cut-away, three-dimensional view of a synchronizing ring as a first exemplary embodiment of the invention;

FIG. 2 is a partly cut-away, three-dimensional view of a further synchronizing ring forming a second exemplary embodiment of the invention; and

FIG. 3 is a longitudinal section taken through the synchronizing ring of FIG. 2.

### DETAILED DESCRIPTION OF THE INVENTION

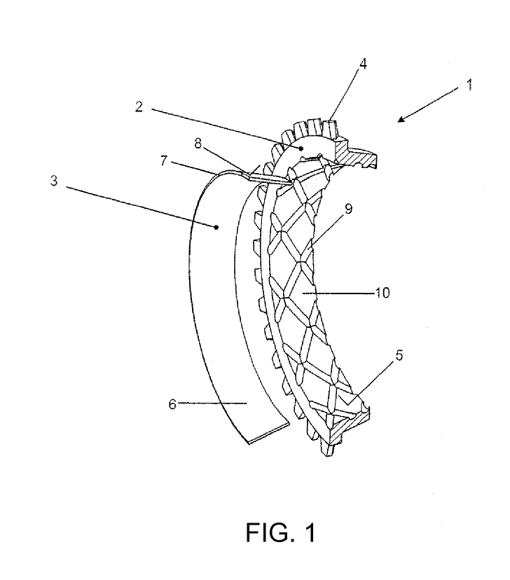

Referring now to the figures of the drawing, where like or mutually corresponding parts are provided with the same or mutually corresponding reference numerals, and first, particularly, to FIG. 1 thereof, there is shown a schematic, partly cut-away, perspective or 3D exploded illustration of a portion of a synchronizing ring 1. The synchronizing ring 1, also referred to as a synchronizer ring 1, is formed from a basic element 2, made for example of brass, and a friction layer lining body 3.

The outer circumference of the basic element 2 has a peripheral, radially outwardly-pointing row of teeth 4 formed to mesh, for example, with a gear wheel of a transmission system. The inner circumference of the basic element 2 has a conically tapering basic element contact surface 5 which assumes a cone angle relative to the axis of rotation of the synchronizing ring 1 of between 6° and 10°.

The friction layer lining body 3 is also conical in its configuration and adapted geometrically to the basic element 2, thus allowing the friction layer lining member 3 to be adhered in a aereal manner to the basic element contact surface 5, as will be described hereinafter in detail. The friction layer lining body 3 has radially inwardly a, by way of example, sintered-on friction coat layer 6 and radially outwardly—as the carrier—a metal foil 7, made for example of steel. The metal foil 7 is in the form of a cone ring. At the radial outside of the metal foil 7, the metal foil has a lining contact surface 8 which is bonded to the basic element contact surface 5 during the bonding process. The metal foil 7 is formed so as to be gas-tight; likewise, the basic element 2 is embodied so as to be gas-tight in the region of the basic element contact surface 5.

In order to avoid loss of strength or shape during the adhesion, the basic element contact surface 5 has a plurality of grooves 9 extending in a criss-cross pattern at an angle to the axial extension of the basic element 2. The grooves 9 are in the form of depressions or depression regions, adhesive surfaces 10, which form the adhesive contact to the friction layer lining body 3 or the metal foil 7, being located between the grooves 9.

As may be seen from FIG. 1, the grooves 9 divide the basic element contact surface 5 so as to form a minimum distance of any desired point of the adhesive surfaces 10 to a possible vent, i.e. to the grooves 9 or to the free edges of the basic element contact surface 5, which is less than the axial extension of the basic element contact surface 5, for example less than two thirds of the basic element contact surface 5 in the aforementioned extension.

The basic element 2 is adhered to the friction layer lining body 3 optionally at elevated temperatures, i.e. at temperatures of greater than 40° C., the adhesive used being for example a film adhesive or phenolic resin adhesive. During the bonding process or during curing of the adhesive, gases, which originate from solvent residues or else from reaction products of the adhesive, can issue from the adhesive volume. The introduction of a ventilation system, which is opened on the edge side and is formed by the grooves 9, allows the gases formed during the formation of gas to be drawn off from the region of the adhesive zone. This prevents the formation of bubbles or deformation of the adhesive layer. In order to be able to ensure sufficient degassing, the grooves 9 are filled with adhesive in the radial direction only in certain portions, so that the grooves 9 are, even when the synchronizing ring 1 is bonded, a ventilation system which is continuous in terms of flow.

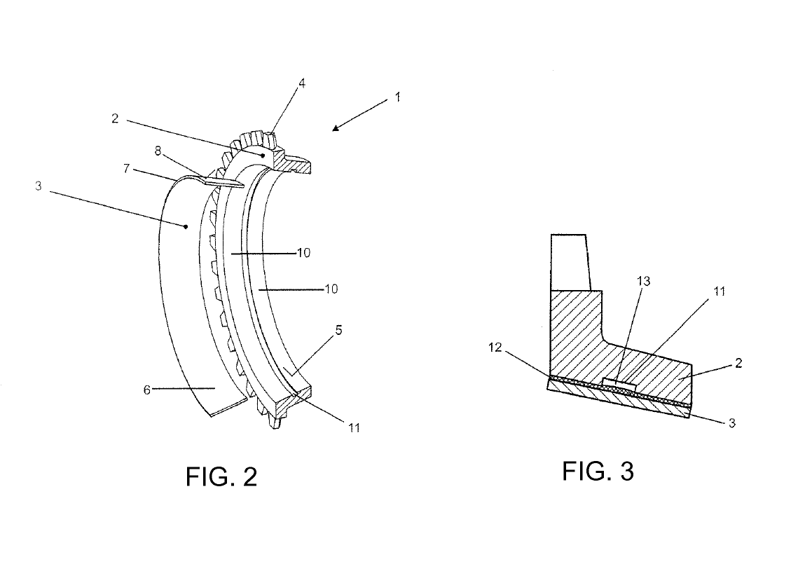

Referring now to FIG. 2, which shows a modification of the first exemplary embodiment shown in FIG. 1, there is provided, instead of a plurality of intersecting grooves 9, a peripheral flute 11. The flute 11 may be introduced by machining, for example, into the basic element 2 in the region of the basic element contact surface 5. The flute 11 or the grooves 9 can be configured from the point of view of cross section in any desired manner, i.e. so as to be rounded, rectangular or for example v-shaped. With regard to the course of the grooves 9 or the flute 11 on the surface to be adhered, there is also broad latitude. Thus, for example channels which extend obliquely to the contact surface, and may also intersect, are beneficial in order to draw off the gas. However, one or more peripheral flutes 11 are—as shown in FIG. 2—also sufficient if one of the two workpieces to be bonded, i.e. the basic element 2 or friction layer lining body 3, has interrupted points over the circumference, at which the gases can issue in order to ensure the degassing operation.

FIG. 3 is a longitudinal section taken through the exemplary embodiment in FIG. 2 with the glued-in friction layer lining body 3. The friction layer lining body 3 extends over the entire basic element contact surface 5, the adhesive 12 being applied in layers between the basic element contact surface 5 and the lining contact surface 8. The adhesive 12 has a substantially uniform thickness over the axial extension and/or in the circumferential direction. In particular, the depth of the flute 11 in the radial direction is selected in such a way that the flute 11 is filled with the adhesive 12 only partially, thus forming a remaining free volume 13. The free volume 13 is in flow communication with the environment, thus allowing gases issuing from the adhesive 12 to be drawn off in the flute 11 via the free volume 13.

1. A friction layer carrier device, comprising:
a basic element formed with a basic element contact surface; and
a friction layer lining body fastened to said basic element, said friction layer lining body having a lining contact surface;
adhesive joining said friction layer lining body to said basic element at adhesive regions, with said contact surface of said basic element adjoining said lining contact surface of said friction layer lining body;
at least one of said basic element contact surface and said lining contact surface having a depression region with depressions formed therein for degassing said adhesive.

2. The friction layer carrier device according to claim 1, wherein said at least one depression region is formed as a ventilation structure for adjoining adhesive regions and/or said depression region is outwardly opened.

3. The friction layer carrier device according to claim 1, wherein said at least one depression region and said adhesive regions are formed so as to define a shortest distance from a point in said adhesive regions to a possible vent in said depression region to be less than 10 mm.

4. The friction layer carrier device according to claim 3, wherein said shortest distance is less than 5 mm.

5. The friction layer carrier device according to claim 3, wherein said shortest distance is less than 3 mm.

6. The friction layer carrier device according to claim 1, wherein said at least one depression region is formed so as to be adhesive-free in certain portions thereof.

7. The friction layer carrier device according to claim 1, wherein said at least one depression region is formed with structures selected from the group consisting of grooves, flutes, a braided pattern, a criss-cross pattern, and channels.

8. The friction layer carrier device according to claim 1, wherein said at least one depression region is formed in said basic element.

9. The friction layer carrier device according to claim 1, wherein one or both of said basic element contact surface and said lining contact surface has a shape selected from the group consisting of flat, curved, cylindrical sleeve-shaped, and conical sleeve-shaped.

10. The friction layer carrier device according to claim 1, wherein one or both of said basic element contact surface and said lining contact surface are gas-tight surfaces.

11. The friction layer carrier device according to claim 1, formed as a brake lining body, a clutch body, or a synchronizing body.

12. The friction layer carrier device according to claim 1, formed as a synchronizer ring.

13. The friction layer carrier device according to claim 1, wherein said friction layer lining body is formed of at least two layers including a metal strip or a sheet metal foil forming a carrier layer and at least one friction coat layer carried on said carrier layer.

14. A synchronizer ring, comprising:
a ring with a cone-shaped and/or conical sleeve surface forming a contact surface; and
a coated metal foil forming a friction layer lining body bonded into said cone-shaped and/or conical sleeve surface; and
adhesive joining said coated metal foil to said basic element at adhesive regions, with said contact surface of said basic element joining said lining contact surface of said friction layer lining body;
at least one of said contact surface of said ring and said metal foil having a depression region with depressions formed therein for degassing said adhesive.

15. A method of producing the friction layer carrier device according to claim 1, which comprises:
providing the basic element having a basic element contact surface and providing a friction layer lining body having a lining contact surface; and
forming at least one depression region for allowing degassing of adhesive by a process step selected from the group consisting of molding, embossing, machining, introducing with cutting, and introducing without cutting into at least one of the basic element contact surface and the lining contact surface.

16. The method according to claim 15, which comprises providing an adhesive layer between the basic element contact surface and the lining contact surface, and selecting a thickness of the adhesive layer in such a way that the at least one depression region is incompletely filled after the adhesion and/or remains connected in terms of flow in the unfilled regions over an entire extent.
